(19) United States
(12) Patent Application Publication
(10) Pub. No.: US 2007/0228321 A1
(43) Pub. Date: Oct. 4, 2007

(54) Coolant for the treatment and production of wafers

(75) Inventors: Louis Hennissen, (US); Bernd Weyershausen, (US)

Correspondence Address: SCULLY SCOTT MURPHY & PRESSER, PC, 400 GARDEN CITY PLAZA, SUITE 300, GARDEN CITY, NY, 11530, US

(73) Assignee: Goldschmidt GmbH, Essen (DE)

(21) Appl. No.: 11/731,241

(22) Filed: Mar. 30, 2007

(30) Foreign Application Priority Data
Mar. 31, 2006 (DE) 10 2006 015 539.4

(51) Int. Cl. C09K 5/00

(52) U.S. Cl. 252/71

(57) ABSTRACT

The invention relates to a coolant for use in the production and/or treatment of ingots and/or wafers, the coolant containing a surfactant in order to improve the quality of the production or treatment.

### FIELD OF THE INVENTION

The present invention relates to a coolant for use in the production and/or treatment of ingots and/or wafers. In addition, the present invention also relates to a process for the production and/or treatment of ingots and/or wafers by means of such a coolant as well as the use of a surfactant in the production and/or treatment of ingots and/or wafers.

### BACKGROUND OF THE INVENTION

Typically, the customary process for the production of wafers comprises, inter alia, the following steps:

producing a so-called “ingot”, i.e., a “tree trunk-like” block of the wafer material;

sawing wafers out of this ingot (so-called dicing);

grinding the wafers to a certain thickness; and

polishing the wafer surface by wet chemical and grinding processes with the use of an abrasive material.

For most applications, the surfaces of the wafers must be polished so that the surfaces are optically reflective. Extreme requirements apply with regard to the evenness of the wafer, the perfection of the polish and the cleanness of the wafer surface. In the semiconductor industry and micromechanics, electronic components, especially integrated circuits (ICs, or “chips”) or micromechanical components, are produced on wafers by various technical processes. In these various technical processes up to completion of a microchip, grinding and polishing processes play an important role. In particular, the so-called “back grinding”, i.e., grinding of the wafer again on the side on which no circuits were applied to the final thickness of the wafer is of key importance.

In the treatment steps, which include sawing or grinding, a coolant is usually used. In most prior art applications, the coolant is typically demineralized water.

It should be noted that, in addition to cooling, for example, during grinding, sawing and the polishing processes, the “coolant” also serves for removing wafer material which has been ground away, both from the surface of the material to be processed and from the environment (including the periphery which is, for example, the grinding chamber). Thus, it would be more accurate in this step to use the term “coolant and separating agent or cleaning agent”. For reasons of clarity, however, exclusively the term coolant will be used in this application, but in the context of the present invention, the term “coolant” is understood as meaning any liquid or virtually liquid medium which is capable of performing one or more of the following functions:

removing the heat which is generated, for example, in the processing processes of the ingot and of the wafers, in particular during grinding in association with porous abrasive material,

removing undesired or abraded material, and

keeping the periphery surrounding the actual processing process, such as, for example, the inner walls of a grinding machine, clean.

In the context of the present invention, the term “wafer” is understood as meaning any material that can be used for producing circuits, in particular microscopically small circuits. In particular, in the meaning of the invention, the term “wafer” is understood as meaning any semiconductor material. A semiconductor material is understood as meaning a solid whose electrical conductivity is greatly temperature-dependent and which can therefore be regarded both as conductor and as a nonconductor, depending on the temperature. The conductivity of a semiconductor increases with increasing temperature, with the result that it may also be designated as a thermistor. The conductivity can be controlled by introducing foreign atoms from another main group, so-called doping atoms, within wide limits. Semiconductors are important for microelectronics, however, in particular in that their conductivity can also be changed by applying a control voltage or a control current (as, for example, in the case of a transistor).

Silicon or a silicon-containing alloys, for example, SiGe, is generally used as wafer material. It should however be noted that, in the context of the present invention, the term “wafer” is also understood as meaning semiconductor materials comprising, for example, germanium, gallium arsenide, gallium nitride, indium phosphide or aluminum gallium arsenide, and the invention can also be applied to wafers comprising these materials. The abovementioned semiconductor materials represent a selection and there therefore is no intention to make any claim to completeness or even to specify a limitation.

In some applications, however, the use of a prior art coolant has the disadvantage that the material to be removed or the sawdust, grinding dust or polishing dust formed during sawing, grinding or polishing is not removed completely from the wafer surface and from the environment of the wafer during the processing process, so that damage to the wafer up to, and including production of waste, can occur in the following operations. Particularly against the background of the emerging trend toward ever thinner wafers, the complete removal of any particles of the semiconductor material to be processed which adhere to the wafer surface plays a greater and greater role since in this case damage to the surface or to layers close to the surface has relatively great consequences.

Moreover, it has been found that in some prior art applications which relate in particular to processes for grinding the wafer, the grinding process cannot be operated continuously in certain circumstances but may stop if the resulting process heat (frictional heat) cannot be removed quickly enough. The downtime may be up to 8-10% of the total time.

Furthermore, according to the prior art, the abrasive material of a grinding disk or of a grinding wheel (, e.g., a rotationally symmetrical body which is produced from particulate abrasive materials and binders and is clamped in a grinding machine and processes, for example, a semiconductor material or wafer at high speeds by precision machining) must as a rule be sharpened approximately once an hour. This requires about 5 minutes, so that approximately a further twelfth of the total time is lost.

In view of the above, there is a need for providing a coolant for the production and/or treatment of ingots and/or wafers, by means of which the disadvantages described above can be overcome or at least substantially avoided. There is also a need for providing a method of using such a coolant for the production and/or treatment of a semiconductor wafer or ingot.

### SUMMARY OF THE INVENTION

The present invention provides a coolant for use in the production and/or treatment of ingots and/or wafers, wherein the coolant contains at least one surfactant.

The term “treatment” is understood throughout the present application as meaning any process for processing the wafers and/or the ingot, in particular sawing, grinding and/or polishing, as well as cleaning.

Surprisingly, it has been found that, by the addition of a surfactant or of a surfactant mixture, the prior art problems described above can be substantially reduced or even eliminated in some applications.

A “surfactant” in the context of the present invention is understood as meaning any substance which is capable of acting on the surface tension between two phases.

Without being bound to any theory, inter alia, the following is considered for the positive properties of the surfactant or of the surfactant mixture:

In many applications in the treatment and production of wafers, diamond grinding wheels are used. The abrasive material or the abrasive layer of these diamond grinding wheels consists of natural or synthetic binding materials which are mixed with different diamond grits. In addition, the abrasive material of modern diamond grinding wheels is porous in order to ensure better cooling or better removal of frictional heat. According to the prior art, abrasive materials or layers having a porosity (expressed in mesh) of a few hundred mesh to, nowadays, about 8000 mesh are usually used, abrasive materials or layers having a porosity of 10,000 mesh or more being announced for the future, since a more uniform and smoother wafer surface can be achieved during grinding with a higher mesh number, which in turn correlates with a finer pore structure (smaller pore size) and smaller diamond grits.

On addition of the surfactant or surfactant mixture according to the invention, it has been surprisingly determined that water is better enabled to penetrate into the pores of the abrasive material or of the abrasive layer and thus leads to better removal of the heat generated during grinding. Moreover, it was surprisingly found that, by the use of the surfactant according to the invention or of the surfactant mixture according to the invention, the abraded material or the grinding dust adheres less well to the wafer surface and to the inner walls of the grinding machine and is more readily removed from the process.

According to a preferred embodiment, the coolant is a water-based coolant, i.e., it contains water as a substantial component. In one embodiment, it is preferable if the water is demineralized water.

According to a preferred embodiment of the present invention, the proportion of surfactant is from >0 to ≦1% by weight of the coolant.

### BRIEF DESCRIPTION OF THE DRAWINGS

FIG. 1 shows a diagram of the current draw during grinding of 100 wafers with a diamond grinding wheel which has a porosity or diamond grit size of 2000 mesh, by a process according to the prior art and with the use of a coolant according to an embodiment of the invention.

FIG. 2 shows a diagram of the current draw during grinding of 100 wafers with a diamond grinding wheel which has a porosity or diamond grit size of 4000 mesh, by a process according to the prior art and with the use of a coolant according to an embodiment of the invention.

FIG. 3 shows a diagram of the current draw during grinding of 100 wafers with a diamond grinding wheel which has a porosity or diamond grit size of 8000 mesh, by a process according to the prior art and with the use of a coolant according to an embodiment of the invention.

### DETAILED DESCRIPTION OF THE INVENTION

The present invention, which provides a coolant for the production and/or treatment of semiconductor wafers and/or ingots, will now be described in greater detail by referring to the following detailed discussion.

As stated above, the present invention provides a coolant for use in the production and/or treatment of ingots and/or wafers, wherein the coolant contains at least one surfactant.

It should be noted that, according to the present invention, the coolant may comprise a single surfactant or a surfactant mixture. For reasons of clarity and simplicity, the term “surfactant” therefore also means a surfactant mixture, and it may be preferable if all surfactants within the surfactant mixture and/or the surfactant mixture as a whole have the properties described below.

Where more than one surfactant is present in the inventive coolant, it is particularly preferred that the total amount of surfactant is from >0 to ≦1% by weight of the coolant.

This amount has been found to be particularly advantageous for most applications. Preferably, the proportion of surfactant is from ≧0.01 to ≦0.5% by weight of the coolant, particularly preferably from ≧0.1 to ≦0.25% by weight.

Preferably, aqueous (demineralized water) solutions containing 0.1% by weight of surfactant having a surface tension of ≦35 mN/m, more preferably ≦30 mN/m and most preferably ≦25 mN/m at 20° C. and 0.5 Hz (frequency on measurement of the surface tension by means of a bubble pressure tensiometer) are employed.

In many applications within the present invention, this has been found to be advantageous since improved heat dissipation can be achieved, in particular, in many applications which include a grinding process.

According to a preferred embodiment of the present invention, a 0.1% by weight surfactant solution has a spread of ≧50 mm, i.e., 50 μl of a 0.1% by weight surfactant-containing aqueous solution spread over a hydrophobic substrate (such as, for example, polypropylene film of the Forco-BOPP type—transparent, 40 μm thickness—from van Leer in Forchheim, Germany) to give a film which covers an area having a mean diameter of ≧50 mm.

Surfactants of the aforementioned type have so-called super-spreading properties and are also referred to as superspreaders and have been found to be particularly advantageous within many applications of the present invention.

A surfactant is a superspreader if the addition of a small amount (on the order of about 0.1% by weight) of this surfactant to a small drop of water enables the latter to spread over a hydrophobic surface within tenths of a second to give a thin film (S. Zhu, W. G. Miller, L. E. Scriven, H. T. Davis, Colloids and Surfaces A 90 (1994) 63).

A 0.1% by weight surfactant solution preferably has a spread of ≧60 mm, particularly preferably ≧65 mm, very particularly preferably ≧70 mm.

According to a preferred embodiment of the present invention, the surfactant has a molecular weight of ≦1500 g/mol. Surfactants of this size are particularly advantageous in most applications of the present invention. The surfactant preferably has a molecular weight of ≦1000 g/mol.

According to a preferred embodiment of the present invention, the at least one surfactant, contains a material having the following structure (herein after structure I):

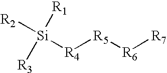

in which R¹, R² and/or R³ independently of one another, are selected from the group consisting of hydrogen, alkyl, long-chain alkyl, alkenyl, alkoxy, long-chain alkoxy, cycloalkyl, aryl, haloalkyl, halogen, pseudohalogen, alkylsilyl and alkylsilyloxy, R⁴ is selected from the group consisting of alkylene, alkenediyl, arylene, haloalkyl, long-chain alkyl, alkyl and cycloalkyl, R⁵ and R⁶ are polyether and R⁷ is selected from the group consisting of hydrogen, hydroxyl, halogen, alkyl, carboxylate, carbonyl, sulfate, sulfonate, amine, phosphonate, phosphine, phosphate, M and ammonium.

General group definition: Within the description and the claims, general groups, such as, for example: alkyl, alkoxy, aryl, etc., are claimed and described. Unless stated otherwise, the following groups are preferably used within the generally described groups for the purposes of the present invention:

Alkyl: linear and branched C₁-C₈-alkyls,

Long-chain alkyls: linear and branched C₅-C₂₀ alkyls,

Alkenyl: C₂-C₆-alkenyl,

Cycloalkyl: C₃-C₈-cycloalkyl,

Alkoxy: C₁-C₆-alkoxy,

Long-chain alkoxy: linear and branched C₅-C₂₀-alkoxy,

Alkylenes: a divalent linear or branched aliphatic, cycloaliphatic or aromatic hydrocarbon radical having 2 to 18 carbon atoms and optionally containing heteroatoms. Examples include:

methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl; 1,4-butylene; 1,4-pentylene, 1,6-hexylene, 1,7-heptylene, 1,8-octylene, 1,9-nonylene, 1,10-decylene, 1,11-undecylene, 1,12-dodecylene, cyclohexane-1,1-diyl; cyclohexane-1,2-diyl; cyclohexane-1,3-diyl; cyclohexane-1,4-diyl; cyclopentane-1,1-diyl; cyclopentane-1,2-diyl; and cyclopentane-1,3-diyl,

Alkenediyl: selected from the group consisting of: 1,2-propenediyl, 1,2-butenediyl, 2,3-butenediyl, 1,2-pentenediyl, 2,3-pentenediyl, 1,2-hexenediyl, 2,3-hexenediyl, 3,4-hexenediyl,

Alkynediyl is —C≡C—,

Aryl: selected from aromatics having a molecular weight of less than 300 Daltons (Da),

Arylenes: selected from the group consisting of: 1,2-phenylene; 1,3-phenylene; 1,4-phenylene; 1,2-naphthylene; 1,3-naphthylene; 1,4-naphthylene; 2,3-naphthylene; 1-hydroxy-2,3-phenylene; 1-hydroxy-2,4-phenylene; 1-hydroxy-2,5-phenylene; and 1-hydroxy-2,6-phenylene,

Amines: the group —N(R)₂ in which each R independently is selected from: hydrogen; C₁C₆-alkyl; C₁-C₆-alkyl-C₆H₅; and phenyl, where, when both R are C₁-C₆-alkyl, they can form an NC₃ to NC₅ heterocyclic ring, the remaining alkyl chain forming alkyl substituents of the ring,

Hydroxyl: —OH,

Halogen: selected from the group consisting of: F; Cl; Br and I,

Haloalkyl: selected from the group consisting of monohalogenated, dihalogenated, trihalogenated, polyhalogenated and perhalogenated linear and branched C₁-C₈-alkyl,

Pseudohalogen: selected from the group containing —CN, —SCN, —OCN, N₃,—CNO, —SeCN,

Sulfonates: the group —S(O)₂OR, in which R is selected from: hydrogen; C₁-C₆-alkyl; phenyl; C₁-C₆-alkyl-C₆H₅; Li; Na; K; Cs; Mg; and Ca,

Sulfates: the group —OS(O)₂OR, in which R is selected from: hydrogen; C₁-C₆-alkyl; phenyl; C₁-C₆-alkyl-C₆H₅; Li; Na; K; Cs; Mg; and Ca,

Sulfones: the group —S(O)₂R, in which R is selected from: hydrogen; C₁-C₆-alkyl; phenyl; C₁-C₆-alkyl-C₆H₅ and amines (resulting in sulfonamide) selected from the group: —NR′₂, in which each R′ independently is selected from: hydrogen; C₁-C₆-alkyl; C₁-C₆-alkyl-C₆H₅; and phenyl, and phenyl, where, when both R are C₁-C₆-alkyl, they can form an NC₃ to NC₅ heterocyclic ring, the remaining alkyl chain forming alkyl substituents of the ring,

Carboxylate: the group —C(O)OR, in which R is selected from: hydrogen; C₁-C₆-alkyl; phenyl; C₁-C₆-alkyl-C₆H₅; Li; Na; K; Cs; Mg; and Ca,

Carbonyl: the group —C(O)R, in which R is selected from: hydrogen; C₁-C₆-alkyl; phenyl; C₁-C₆-alkyl-C₆H₅ and amine (resulting in an amide) selected from the group: —NR′₂, in which each R′ independently is selected from: hydrogen; C₁-C₆-alkyl; C₁-C₆-alkyl-C₆H₅; and phenyl, where, when both R are C₁-C₆-alkyl, they can form an NC₃ to NC₅ heterocyclic ring, the remaining alkyl chain forming alkyl substituents of the ring,

Phosphonates: the group —P(O)(OR)₂, in which each R independently is selected from: hydrogen; C₁-C₆-alkyl; phenyl; C₁-C₆-alkyl-C₆H₅; Li; Na; K; Cs; Mg; and Ca,

Phosphates: the group —OP(O)(OR)₂, in which each R independently is selected from: hydrogen; C₁-C₆-alkyl; phenyl; C₁-C₆-alkyl-C₆H₅; Li; Na; K; Cs; Mg; and Ca,

Phosphines: the group —P(R)₂, in which each R independently is selected from: hydrogen; C₁-C₆-alkyl; phenyl; and C₁-C₆-alkyl-C₆H₅,

Phosphine oxide: the group —P(O)R₂, in which R independently is selected from: hydrogen; C₁-C₆-alkyl; phenyl; and C₁-C₆-alkyl-C₆H₅ and amine (phosphonamidate) selected from the group: —NR′₂, in which each R′ independently is selected from: hydrogen; C₁-C₆-alkyl; C₁-C₆-alkyl-C₆H₅; and phenyl, where, if both R are C₁-C₆-alkyl, they may form an NC₃ to NC₅ heterocyclic ring, the remaining alkyl chain forming alkyl substituents of the ring,

Polyether: selected from the group containing —O—CH (R₁)—CH(R₂))ₙ— in which R₁ and R₂ independently are selected from: hydrogen, alkyl, aryl, halogen and n is from 1 to 250, preferably from 1 to 20, and —(O—CH₂—CH(R))ₙ—OH and —(O—CH₂—CH(R))ₙ—OR in which R independently is selected from: hydrogen, methyl, ethyl, propyl, phenyl, halogen and n is from 1 to 250, preferably from 1 to 20,

Alkylsilyl: the group —SiR₁R₂R₃, in which R₁, R₂ and R₃ independently of one another are selected from: hydrogen; alkyl; long-chain alkyl, phenyl, cycloalkyl, haloalkyl, alkoxy, long-chain alkoxy,

Alkylsilyloxy: the group —O—SiR₁R₂R₃, in which R₁, R₂ and R₃ independently of one another are selected from: hydrogen; alkyl; long-chain alkyl, phenyl, cycloalkyl, haloalkyl, alkoxy, long-chain alkoxy,

Ammonium: the group —N⁺R₁R₂R₃, in which R₁, R₂ and R₃ independently of one another are selected from: hydrogen; alkyl; long-chain alkyl, phenyl, cycloalkyl, haloalkyl, alkoxy, long-chain alkoxy,

M, Mₙ (n is an integer): metals, two metals M being selected independently from one another, unless indicated otherwise.

Unless otherwise mentioned, the following groups are particularly preferred within the general group definition:

Alkyl: linear and branched C₁-C₆-alkyl,

Long-chain alkyls: linear and branched C₅-C₁₀-alkyl, preferably C₆-C₈-alkyls,

Alkenyl: C₃-C₆-alkenyl,

Cycloalkyl: C₆-C₈-cycloalkyl,

Alkoxy: C₁-C₄-alkoxy,

Long-chain alkoxy: linear and branched C₅-C₁₀-alkoxy, preferably linear C₆-C₈-alkoxy,

Alkylenes: a divalent linear or branched aliphatic, cycloaliphatic, or aromatic hydrocarbon radical having 2 to 18 carbon atoms and optionally containing heteroatoms. Suitable alkylenes include, for example,

methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl; 1,4-butylene; 1,4-pentylene, 1,6-hexylene, 1,7-heptylene, 1,8-octylene, 1,9-nonylene, 1,10-decylene, 1,11-undecylene, 1,12-dodecylene, cyclohexane-1,1-diyl; cyclohexane-1,2-diyl; cyclohexane-1,3-diyl; cyclohexane-1,4-diyl; cyclopentane-1,1-diyl; cyclopentane-1,2-diyl; and cyclopentane-1,3-diyl,

Aryl: selected from the group consisting of: phenyl; biphenyl; naphthyl; anthracenyl; and phenanthrenyl,

Arylene: selected from the group consisting of: 1,2-phenylene; 1,3-phenylene; 1,4-phenylene; 1,2-naphthylene; 1,4-naphthylene; 2,3-naphthylene and 1-hydroxy-2,6-phenylene,

Amines: the group —N(R)₂, in which each R independently is selected from: hydrogen; C₁-C₆-alkyl; and benzyl,

Halogen: selected from the group consisting of: F and Cl,

Hydroxyl: —OH,

Sulfonates: the group —S(O)₂OR, in which R is selected from: hydrogen; C₁-C₆-alkyl; Na; K; Mg; and Ca,

Sulfates: the group —OS(O)₂OR, in which R is selected from: hydrogen; C₁-C₆-alkyl; Na; K; Mg; and Ca,

Sulfones: the group —S(O)₂R, in which R is selected from: hydrogen; C₁-C₆-alkyl; benzyl and amines selected from the group: —NR′₂, in which each R′ independently is selected from: hydrogen; C₁-C₆-alkyl; and benzyl,

Carboxylate: the group —C(O)OR, in which R is selected from hydrogen; Na; K; Mg; Ca; C₁-C₆-alkyl; and benzyl,

Carbonyl: the group —C(O)R, in which R is selected from: hydrogen; C₁-C₆-alkyl; benzyl and amines selected from the group: —NR′₂, in which each R′ independently is selected from: hydrogen; C₁-C₆-alkyl; and benzyl,

Phosphonates: the group —P(O)(OR)₂, in which each R independently is selected from: hydrogen; C₁-C₆-alkyl; benzyl; Na; K; Mg; and Ca,

Phosphates: the group —OP(O)(OR)₂, in which each R independently is selected from: hydrogen; C₁-C₆-alkyl; benzyl; Na; K; Mg; and Ca,

Phosphines: the group —P(R)₂, in which each R independently is selected from: hydrogen; C₁-C₆-alkyl; and benzyl,

Phosphine oxide: the group —P(O)R₂, in which R independently is selected from: hydrogen; C₁-C₆-alkyl; benzyl and amines selected from the group: —NR′₂, in which each R′ independently is selected from: hydrogen; C₁-C₆-alkyl; and benzyl,

Polyether: selected from the group consisting of —O—CH(R₁)—CH(R₂))ₙ—, in which R₁ and R₂ independently are selected from: hydrogen, methyl, ethyl, propyl, phenyl, halogen and n is from 1 to 50, preferably from 1 to 15, and —(O—CH₂—CH(R))ₙ—OH and —(O—CH₂—CH(R))ₙ—OR, in which R independently is selected from: hydrogen, methyl, ethyl, propyl, phenyl, halogen and n is from 1 to 50, preferably from 1 to 15,

Alkylsilyl: the group —SiR₁R₂R₃, in which R₁, R₂ and R₃ independently of one another are selected from: hydrogen; methyl, ethyl, propyl, phenyl; methoxy, ethoxy and propoxy

Alkylsilyloxy: the group —O—SiR₁R₂R₃, in which R₁, R₂ and R₃ independently of one another are selected from: hydrogen; methyl, ethyl, propyl, phenyl; methoxy, ethoxy and propoxy,

Ammonium: the group —N⁺R₁R₂R₃, in which R₁, R₂ and R₃ independently of one another are selected from: hydrogen; methyl, ethyl, propyl, phenyl; long-chain alkyl, benzyl, cycloalkyl,

M, Mₙ (n is an integer): metals, two metals M being selected independently of one another, unless indicated otherwise.

According to a preferred embodiment of the present invention, the at least one surfactant contains a material having the following structure (hereinafter structure II):

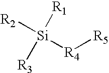

in which R¹, R² and/or R³, independently of one another, are selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, and R⁴ is selected from the group consisting of alkylene, alkenediyl, arylene, haloalkyl, long-chain alkyl, alkyl, cycloalkyl, polyether, and R⁵ is selected from the group consisting of hydrogen, hydroxyl, halogen, alkyl, polyether, carboxylate, carbonyl, sulfate, sulfonate, amine, phosphonate, phosphine, phosphate, M and ammonium.

According to a preferred embodiment of the present invention, the at least one surfactant contains a material having the following structure (hereinafter structure III):

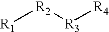

in which R¹ is selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, R² is selected from the group consisting of alkylene, alkenediyl, alkynediyl, arylene, haloalkyl, long-chain alkyl, alkyl, cycloalkyl and polyether, R³ is polyether and R⁴ is selected from the group consisting of hydrogen, hydroxyl, alkyl, carboxylate, carbonyl, sulfate, sulfonate, amine, phosphonate, phosphine, phosphate, M and ammonium.

According to a preferred embodiment of the present invention, the at least one surfactant contains a material having the following structure (hereinafter structure IV):

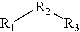

in which R¹ is selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, R² is selected from the group consisting of alkylene, alkenediyl, alkynediyl, arylene, haloalkyl, long-chain alkyl, alkyl, cycloalkyl and polyether, and

R³ is selected from the group consisting of hydrogen, hydroxyl, alkyl, carboxylate, carbonyl, sulfate, sulfonate, amine, phosphonate, phosphine, phosphate, M and ammonium.

According to a preferred embodiment of the present invention, the at least one surfactant contains a material having the following structure (hereinafter structure V):

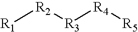

in which

R¹ and R² independently of one another are selected from the group consisting of hydrogen, alkyl, long-chain alkyl, alkenyl, alkylene, alkoxy, long-chain alkoxy, cycloalkyl, aryl, haloalkyl, halogen, pseudohalogen, alkylsilyl, alkylsilyloxy, polyether; R³ is polyether or alkynediyl; R⁴ is alkylene or polyether; and R⁵ is selected from the group consisting of hydrogen, hydroxyl, alkyl, carboxylate, carbonyl, sulfate, sulfonate, amine, phosphonate, phosphine, phosphate, polyether, M and ammonium.

According to a preferred embodiment of the present invention, the at least one surfactant contains a material having the following structure (hereinafter structure VI):

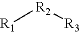

in which R¹ and R² independently of one another are selected from the group consisting of hydrogen, alkyl, long-chain alkyl, alkenyl, alkylene, alkoxy, long-chain alkoxy, cycloalkyl, aryl, haloalkyl, halogen, pseudohalogen, alkylsilyl, alkylsilyloxy, polyether

and R³ is selected from the group consisting of hydrogen, hydroxyl, alkyl, carboxylate, carbonyl, sulfate, sulfonate, amine, phosphonate, phosphine, phosphate, polyether, M and ammonium.

The present invention also relates to the use of a surfactant as described above in the production and/or treatment of ingots and/or wafers.

The present invention also relates to a process for the treatment and/or production of ingots and/or wafers, wherein a coolant, as described above, is used.

The above mentioned components and the components claimed and described in the working examples and to be used according to the invention are subject to no particular exceptions in their size, form, choice of material and technical conception, so that the selection criteria known in the field of use can be applied without restriction.

Further details, features and advantages of the subject of the invention are evident from the independent claims and from the following description of the associated drawings in which—by way of example—a plurality of working examples with the use of a coolant according to the invention are shown.

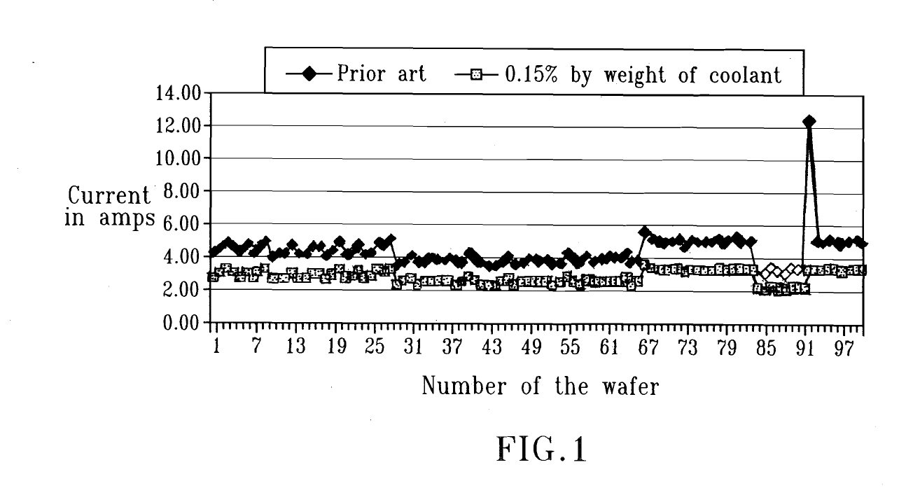

FIG. 1 shows a diagram of the current draw during grinding of 100 wafers with a diamond grinding wheel which has a porosity or diamond grit size of 2000 mesh in a grinding process using a coolant according to the prior art, and a coolant according to a first embodiment of the invention.

In this embodiment, the coolant used was demineralized water having a concentration of 0.15% by weight of a surfactant. A solution of 0.1% by weight of this surfactant in demineralized water has a surface tension of 22.6 mN/m, measured by the “dynamic” method (according to the manufacturer's data with a “SITA science line t60” measuring instrument), at 20° C. and a frequency of 0.5 Hz. On the other hand, the coolant according to the prior art was only demineralized water.

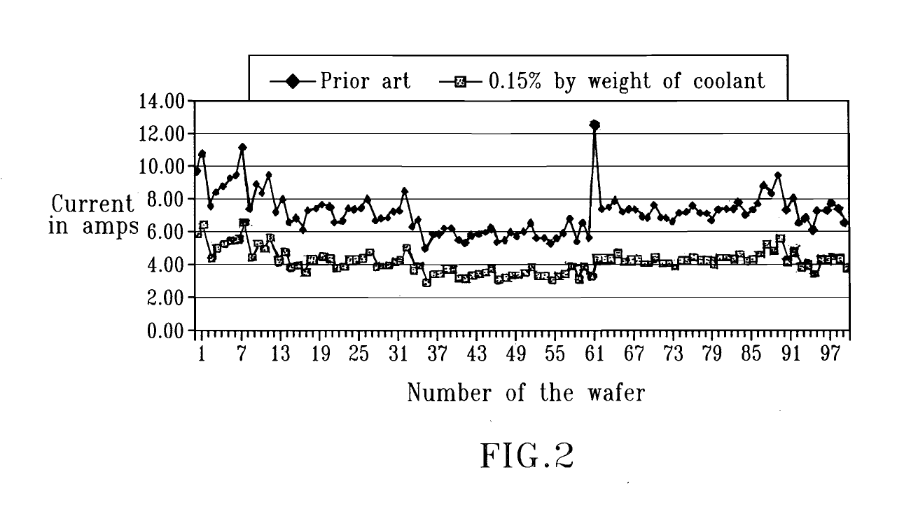

FIG. 2 shows a diagram similar to FIG. 1, the chosen coolant was the same one; the only difference was the finer porosity or diamond grit size (=4000 mesh) of the grinding wheel.

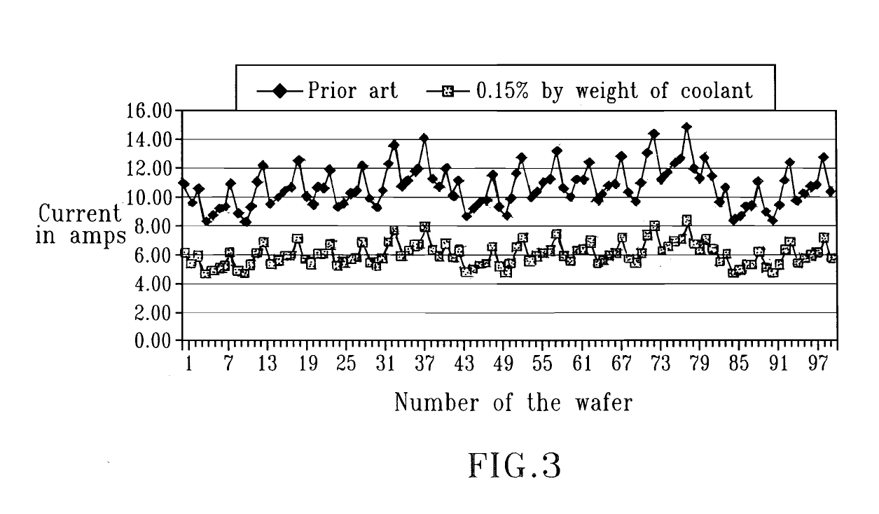

FIG. 3 shows a diagram analogous to FIG. 1 and FIG. 2 with an even finer porosity or diamond grit size (8000 mesh).

The current draw provides conclusions with regard to the uniformity of the grinding process and the force which acts on the wafer surface during grinding. In general, it may be said that, the higher the current draw, the higher are the forces acting on the wafer surface and the wear of the diamond grinding wheel. Furthermore, it is possible to assess the uniformity of the grinding process on the basis of the current draw. The above mentioned forces acting on the wafer surface during grinding are one of the main reasons for damage to the wafer surface and layers close to the surface. In addition, it should be noted that the grinding machine automatically switches off for safety reasons above a load of 14 A, with the result that valuable time is lost since the grinding process has to be readjusted in such a case. In summary, it may be said that there is a direct relationship between the quality of wafers, in particular with a view to surface characteristics (evenness and smoothness) and damage and the current draw—the smaller the quantity of current draw, the higher the quality of the resulting wafers.

As expected, the current draw and hence the loading of the wafers initially increased, both in the grinding process (back grinding of wafer to small layer thickness) in the case of the wafers which were treated by a process according to the prior art and in the case of the wafers where a coolant according to the invention was used, with increasing mesh of the grinding wheel. Larger mesh values (#) mean smaller pore size and finer diamond grits.

However, it was striking that, particularly in the case of 8000 mesh, the process according to the prior art exerted such high loads on the wafer that many of these wafers have a lower quality. In addition—as is evident in all figures—a relatively large number of “outliers” occurred in the case of a coolant according to the prior art, i.e., firstly the process reliability with regard to a continuous sequence is not ensured, and secondly a greatly increased proportion of rejected wafers was expected.

On the other hand, the use of a coolant according to the invention firstly lead to a generally lower load, even by a factor of 2 in the case of 8000 mesh, and secondly no or virtually no “outliers” are observable, i.e., the production process took place generally more reliably and precisely.

Lower forces acting on the wafer surface, which lead to less surface damage, and an overall more reliable grinding process were effects of the use of surfactants according to the invention. These effects can be detected or measured “microscopically” through the current draw of the grinding process. In addition, however, positive effects which were visible to the naked eye and can be attributed to the use of the surfactants according to the invention were also found. Thus, the grinding chamber remained clean when the coolants according to the invention were used and the wear of the diamond grinding wheels was also less in comparison with the process according to the prior art. The cleaner grinding chamber indicated that the grinding dust (semiconductor material removed from the wafer) and in particular coarser particles were better removed from the process and therefore no longer adhered so strongly to the wafer surface, which presented a problem in subsequent process steps in the process according to the prior art and also frequently lead to damage including destruction of the wafers.

Methods of Measurement

The surface tension of a 0.1% strength (% by weight) aqueous (demineralized water) surfactant solution was determined at 20° C. using a “SITA science line t60” measuring instrument at 0.5 Hz according to the manufacturer's data.

The area of spread=area or spread=mean diameter of said area which a liquid film covers was determined as follows:

The area which an aqueous solution of the surfactant to be investigated, at a surfactant concentration of 0.1% by weight, covers on a defined substrate (liquid film) when a defined volume of said solution was applied was determined.

For this purpose, firstly the 0.1% strength aqueous solution was prepared using demineralized water at relative humidity of at least 40%. A defined polypropylene film (from van Leer in Forchheim, Germany, type: Forco-BOPP, color: colorless and transparent, layer thickness: 40μm) was then fixed on a glass plate which was placed on graph paper. With the aid of a μl syringe or pipette, 50 μl were drawn up and the surfactant solution was then dropped onto the polypropylene film from a height of about 5 mm. After 90 seconds, the outer edge of the liquid film which had formed was marked. The longest diameter (a) and the shortest diameter (b) of the liquid film were now measured by means of the graph paper and noted. This measurement was carried out at least twice and the mean value of (a) and (b) was calculated.

The area of spread (ellipse) was stated in cm² and was defined as (cm²)=(πab)/4. The spread was then calculated therefrom and stated in mm; mm=2√(A/π).

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the present claims.

What is claimed is:

1. A coolant for use in the production and/or treatment of ingots and/or wafers, said coolant comprises at least one surfactant.

2. The coolant as claimed in claim 1, wherein said at least one surfactant is employed in a proportion of from ≧0 to ≦1% by weight of the coolant.

3. The coolant as claimed in claim 1, wherein said coolant is an aqueous solution containing 0.1% by weight of said at least one surfactant, said at least one surfactant having a surface tension of ≦35 mN/m at 20° C. and 0.5 Hz.

4. The coolant as claimed in claim 1, wherein said coolant is a 0.1% by weight solution of said at least one surfactant that has a spread of ≧50 mm.

5. The coolant as claimed in claim 1, wherein said at least one surfactant has a molecular weight of ≦1500 (g/mol).

6. The coolant as claimed in claim 1, wherein said at least one surfactant contains a material having the following structure: 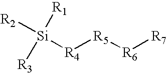
in which R¹, R² and/or R³ independently of one another, are selected from the group consisting of hydrogen, alkyl, long-chain alkyl, alkenyl, alkoxy, long-chain alkoxy, cycloalkyl, aryl, haloalkyl, halogen, pseudohalogen, alkylsilyl and alkylsilyloxy, R⁴ is selected from the group consisting of alkylene, alkenediyl, arylene, haloalkyl, long-chain alkyl, alkyl and cycloalkyl, R⁵ and R⁶ are polyether and R⁷ is selected from the group consisting of hydrogen, hydroxyl, halogen, alkyl, carboxylate, carbonyl, sulfate, sulfonate, amine, phosphonate, phosphine, phosphate, metal and ammonium.

7. The coolant as claimed in claim 1, wherein said at least one surfactant contains a material having the following structure: 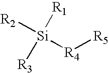
in which R¹, R² and/or R³, independently of one another, are selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, and R⁴ is selected from the group consisting of alkylene, alkenediyl, arylene, haloalkyl, long-chain alkyl, alkyl, cycloalkyl, polyether, and R⁵ is selected from the group consisting of hydrogen, hydroxyl, halogen, alkyl, polyether, carboxylate, carbonyl, sulfate, sulfonate, amine, phosphonate, phosphine, phosphate, metal and ammonium.

8. The coolant as claimed in claim 1, wherein said at least one surfactant contains a material having the following structure: 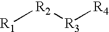
in which R¹ is selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, R² is selected from the group consisting of alkylene, alkenediyl, alkynediyl, arylene, haloalkyl, long-chain alkyl, alkyl, cycloalkyl and polyether, R³ is polyether and R⁴ is selected from the group consisting of hydrogen, hydroxyl, alkyl, carboxylate, carbonyl, sulfate, sulfonate, amine, phosphonate, phosphine, phosphate, metal and ammonium.

9. The coolant as claimed in claim 1, wherein said at least one surfactant contains a material having the following structure: 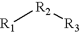
in which R¹ is selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, R² is selected from the group consisting of alkylene, alkenediyl, alkynediyl, arylene, haloalkyl, long-chain alkyl, alkyl, cycloalkyl and polyether, and R³ is selected from the group consisting of hydrogen, hydroxyl, alkyl, carboxylate, carbonyl, sulfate, sulfonate, amine, phosphonate, phosphine, phosphate, metal and ammonium.

10. The coolant as claimed in claim 1, wherein said at least one surfactant contains a material having the following structure: 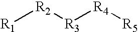
in which R¹ and R² independently of one another are selected from the group consisting of hydrogen, alkyl, long-chain alkyl, alkenyl, alkylene, alkoxy, long-chain alkoxy, cycloalkyl, aryl, haloalkyl, halogen, pseudohalogen, alkylsilyl, alkylsilyloxy, polyether and R³ is polyether or akynediyl, and R⁴ is alkylene or polyether, and R⁵ is selected from the group consisting of hydrogen, hydroxyl, alkyl, carboxylate, carbonyl, sulfate, sulfonate, amine, phosphonate, phosphine, phosphate, polyether, metal and ammonium.

11. The coolant as claimed in claim 1, wherein said at least one surfactant contains a material having the following structure: 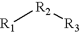
in which R¹ and R² independently of one another are selected from the group consisting of hydrogen, alkyl, long-chain alkyl, alkenyl, alkylene, alkoxy, long-chain alkoxy, cycloalkyl, aryl, haloalkyl, halogen, pseudohalogen, alkylsilyl, alkylsilyloxy, polyether and R³ is selected from the group consisting of hydrogen, hydroxyl, alkyl, carboxylate, carbonyl, sulfate, sulfonate, amine, phosphonate, phosphine, phosphate, polyether, metal and ammonium.

12. A process for the treatment and/or production of at least one of an ingot and a wafer, comprising contacting said at least one ingot and wafer with a coolant, said coolant comprises at least one surfactant.

13. The process as claimed in claim 12, wherein said at least one surfactant is employed in a proportion of from ≧0 to ≦1% by weight of the coolant.

14. The process as claimed in claim 12, wherein said coolant is an aqueous solution containing 0.1% by weight of said at least one surfactant, said at least one surfactant having a surface tension of ≦35 mN/m at 20° C. and 0.5 Hz.

15. The process as claimed in claim 12, wherein said at least one surfactant contains a material having the following structure: 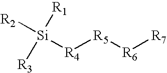
in which R¹, R² and/or R³ independently of one another, are selected from the group consisting of hydrogen, alkyl, long-chain alkyl, alkenyl, alkoxy, long-chain alkoxy, cycloalkyl, aryl, haloalkyl, halogen, pseudohalogen, alkylsilyl and alkylsilyloxy, R⁴ is selected from the group consisting of alkylene, alkenediyl, arylene, haloalkyl, long-chain alkyl, alkyl and cycloalkyl, R⁵ and R⁶ are polyether and R⁷ is selected from the group consisting of hydrogen, hydroxyl, halogen, alkyl, carboxylate, carbonyl, sulfate, sulfonate, amnine, phosphonate, phosphine, phosphate, metal and ammonium.

16. The process as claimed in claim 12, wherein said at least one surfactant contains a material having the following structure: 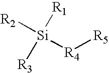
in which R¹, R² and/or R³, independently of one another, are selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, and R⁴ is selected from the group consisting of alkylene, alkenediyl, arylene, haloalkyl, long-chain alkyl, alkyl, cycloalkyl, polyether, and R⁵ is selected from the group consisting of hydrogen, hydroxyl, halogen, alkyl, polyether, carboxylate, carbonyl, sulfate, sulfonate, amine, phosphonate, phosphine, phosphate, metal and ammonium.

17. The process as claimed in claim 12, wherein said at least one surfactant contains a material having the following structure: 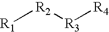
in which R¹ is selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, allcylsilyloxy, R² is selected from the group consisting of alkylene, alkenediyl, alkynediyl, arylene, haloalkyl, long-chain alkyl, alkyl, cycloalkyl and polyether, R³ is polyether and R⁴ is selected from the group consisting of hydrogen, hydroxyl, alkyl, carboxylate, carbonyl, sulfate, sulfonate, amine, phosphonate, phosphine, phosphate, metal and ammonium.

18. The process as claimed in claim 12, wherein said at least one surfactant contains a material having the following structure: 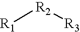
in which R¹ is selected from the group consisting of hydrogen, alkyl, long-chain alkyl, alkenyl, alkoxy, long-chain alkoxy, cycloalkyl, aryl, haloalkyl, halogen, pseudohalogen, alkylsilyl, alkylsilyloxy, R² is selected from the group consisting of alkylene, alkenediyl, alkynediyl, arylene, haloalkyl, long-chain alkyl, alkyl, cycloalkyl and polyether, and R³ is selected from the group consisting of hydrogen, hydroxyl, alkyl, carboxylate, carbonyl, sulfate, sulfonate, amine, phosphonate, phosphine, phosphate, metal and ammonium.

19. The process as claimed in claim 12, wherein said at least one surfactant contains a material having the following structure: 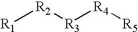
in which R¹ and R² independently of one another are selected from the group consisting of hydrogen, alkyl, long-chain alkyl, alkenyl, alkylene, alkoxy, long-chain alkoxy, cycloalkyl, aryl, haloalkyl, halogen, pseudohalogen, alkylsilyl, alkylsilyloxy, polyether and R³ is polyether or alkynediyl, and R⁴ is alkylene or polyether, and R⁵ is selected from the group consisting of hydrogen, hydroxyl, alkyl, carboxylate, carbonyl, sulfate, sulfonate, amine, phosphonate, phosphine, phosphate, polyether, metal and ammonium.

20. The process as claimed in claim 12, wherein said at least one surfactant contains a material having the following structure: 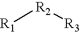
in which R¹ and R² independently of one another are selected from the group consisting of hydrogen, alkyl, long-chain alkyl, alkenyl, alkylene, alkoxy, long-chain alkoxy, cycloalkyl, aryl, haloalkyl, halogen, pseudohalogen, alkylsilyl, alkylsilyloxy, polyether and R³ is selected from the group consisting of hydrogen, hydroxyl, alkyl, carboxylate, carbonyl, sulfate, sulfonate, amine, phosphonate, phosphine, phosphate, polyether, metal and ammonium.
